(19) United States
(12) Patent Application Publication
(10) Pub. No.: US 2007/0241925 A1
(43) Pub. Date: Oct. 18, 2007

(54) Alarm

(76) Inventor: George Andrew Sharpe, Ramsgate (GB)

Correspondence Address: MANELLI DENISON & SELTER PLLC, 7th Floor, 2000 M Street, N.W., Washington, DC, 20036-3307, US

(21) Appl. No.: 11/729,885

(22) Filed: Mar. 30, 2007

Related U.S. Application Data
(60) Provisional application No. 60/789,931, filed on Apr. 7, 2006.

(51) Int. Cl. G08B 23/00; G08B 21/00

(52) U.S. Cl. 340/693.9; 340/540

(57) ABSTRACT

The invention relates to an alarm. More particularly the invention relates to an alarm for use with a door, the alarm is adapted to be retrofitted in an existing door. In large buildings, typically hospitals, offices, hotels, industrial departments or ships, where there are very many similar doors in long corridors, it is often difficult to pinpoint the location of a fire or smoke hazard in a particular room or office, from the perspective of a fireman who may be trying to locate the fire or smoke from the corridor. The invention provides an alarm having means to detect a hazard and means to indicate that a hazard has been detected, characterised in that the means to detect a hazard is located so that it is presented to an inner surface of a door and the means to indicate that a hazard has been detected is located on an outer surface of a door. Ideally a coloured indicator, which may be spring-loaded, is arranged to displace so that a person located in a corridor can identify it. The indicator may include a flashing light, audible or radio frequency (RF) signal or other similar indicator.

### BACKGROUND

The present invention relates to an alarm, and more particularly, but not exclusively, it relates to an alarm for use with a door.

There are many types of door alarms. Typically these door alarms are intruder type alarms and are triggered when there is unauthorised entry. The present invention relates to an alarm, which is triggered when there is a hazard, for example fire or smoke.

In large buildings, for example hospitals, offices, hotels or industrial departments or laboratories, it is often difficult to pinpoint the location of a fire or smoke hazard in a particular room or office, from the perspective of a fireman who may be trying to locate the fire or smoke from a corridor of many similar doors. This problem is exacerbated when visibility is impaired, for example as a result of the corridor being filled with smoke.

### PRIOR ART

UK Patent Application GB-A-2 278 477 (Austin) describes a device for sensing smoke and fumes for use on one side of a door. The device comprises a sensing means connected to an alarm and is adapted to be hooked over the top of a door. An advantage of the device is that it is portable. However, this means that the device is subject to vandalism or inadvertent removable.

Another example of an alarm for use with a door is the smoke alarm described in US Patent U.S. Pat. No. 5,886,637 (Stukey). The alarm is capable of being fitted into the frame of a door along an edge within a recess extended inwardly into the body of the door. Considerable machining of the door is required in order to form a recess of suitable dimensions to receive the alarm. In addition, because the alarm needs to be fitted into an edge of the door, (typically an upper edge of the door), it may be required to remove the door from its hinges in order to fit the alarm. A disadvantage has been therefore that it was necessary to remove the door from its hinges in order to fit the alarm.

Another example of a temperature indicator for mounting on a door or wall is described in UK Patent Application GB-A-2 302 586 (Thermographic Measurements Limited) a temperature indicating device is mounted on one side of the door (or wall) and a temperature sensor is mounted on the opposite side of the door. The device provides a simple warning to a passerby of an elevated temperature within the room. This device was limited in that it could only be viewed from a position relatively close to the door.

The present invention arose in order to provide an improved alarm that did does not suffer from the aforementioned problems.

### SUMMARY OF THE INVENTION

According to a first aspect of the present invention there is provided an alarm that is adapted to be retrofitted into a door, the alarm having a displaceable member, which projects beyond the plane of the door so as to indicate to an observer that there is a hazard in the room which is sealed by the door.

Use of the invention therefore enables a fireman for example to see from a distance, for example in a smoke filled corridor, in which room the fire or hazard is present.

Typically the alarm may include one or more sensors arranged to trigger when a hazard, other than smoke or fire, is sensed. The indicator may include: a visual and/or audio and/or other alarm signal so as to alert someone as to the presence of a hazard.

It will also be appreciated that where no hazard is present, the alarm may be used as a confirmation of status that the room or office is space enclosed by the door safe for entry. Thus an authorised inspector—such as a fireman or fire officer—pushes the displaceable member and thereby verifies the safety status of the room.

According to a second aspect of the present invention there is provided an alarm that has means to detect a hazard and means to indicate that a hazard has been detected, the alarm being housed in a housing, said housing is adapted to be fitted within a door, whereby in use the means to detect a hazard is located at a first surface of the door and the means to indicate that a hazard has been detected is located at the second surface of the door, characterised in that the means to indicate that a hazard has been detected is a displaceable member that is adapted to protrude beyond the surface of the door.

Ideally the housing is heat proof and is capable of withstanding temperatures in excess of 200° C., preferably 300° C.

Although reference has been made to a door, it will also be understood that the alarm may be used in a bulkhead, for example on ships or submarines or any other solid structure that seals, isolates or closes a space.

The alarm is ideally mounted in the body of a door so that one or more sensors are presented to a room or space behind the door, which is sealed in normal use by the door. An indicator, which is ideally a flashing light or stroboscope, is provided to illuminate a location outside the room, for example on the outside surface of the door, so as to be seen from a corridor, walkway or gantry. An advantage with this is that, for example a fireman performing a search of a building in the event of a fire or smoke hazard, when passing along a corridor of many doors, is able to quickly assess in which of the rooms the hazard is present.

One way this is achieved is to provide a visual indicator on the alarm, for example one or more flashing bright light emitting diodes (LED's). This flashing bright light(s) indicate(s) to the person performing the search or surveying the building, where the hazard(s) is/are located.

Other indicator means include: a mechanical device which is typically spring loaded and may be adapted to be displaced from a door so as to indicate a room in which a hazard is present; an audible device which is adapted to emit an audible alarm; a radio frequency (RF) transmitter arranged to transmit an RF signal to a remote station or any combination of these.

The displaceable member is preferably a spring-loaded device and is ideally in the form of a plunger and may be adapted so that, once released, as a result of a hazard it does not depress and ideally it does not depress inward unless batteries or power cells are correctly positioned. This may be achieved by way of a non-return device or locking mechanism.

In the case of the plunger the spring locking mechanism acts as a practical affirmation to test whether a hazard is present. This is achieved by depressing the plunger after activation. If the plunger resets to its ‘passive’ inward position it indicates a safe environment. Should the plunger refuse to ‘reset’, this indicates a hazard remains in existence, as the plunger is triggered. Untrained personnel may use this aspect of the alarm, as a test feature.

Sensors may be of the type for detecting smoke, heat, flames, gas or other noxious substances; biological material, hazardous chemicals or radioactive substances. It will be appreciated that other forms of sensor or detector including moisture detectors may be incorporated into a sensor housing depending upon the location of the sensor and the type of environment in which it is intended to be used.

Advantageously a sensor housing contains or supports the sensor and is presented to a position where the sensor is within close proximity to, or in immediate contact with, a room or volume within an office on the interior side of the door. The sensor housing is preferably arranged to be part of the alarm housing and in a particularly preferred embodiment of the invention a small passage or channel is provided to it in the body of the door and provides a pathway for smoke or gas, in a room, to the sensor.

The alarm housing is dimensioned and arranged to receive the alarm one or more controllers, an energy supply (such as a battery or cell), drive means for the alarm and ideally an anti-tamper mechanism.

In a preferred embodiment the housing comprises two substantially cylindrical housings and is kidney shaped in cross section. A first housing receives the indicator means the second housing houses sensors, control circuitry and electronic communication devices.

The alarm is ideally housed within one or more circularly symmetric housing, such as right circular cylinder, and is suitably sealed against attack from heat, moisture or other substances liable to render it ineffective. The fact that the housing is circularly symmetric means that it may be readily received within an aperture formed in a door, for example with one or more drills. This greatly reduces the amount of carpentry that has to e performed on a door for example and greatly aids installation by reducing the amount of time needed to fit the alarm.

A housing receiving means may be provided which is adapted to receive the alarm housing and which is ideally fitted before the alarm is inserted into an aperture formed in the door. The housing preferably has receiving means fitted with anti tamper device such as tongue in groove type sprung tags, which ensure that the alarm can only be removed by authorised personnel carrying special tools.

Typically the alarm is between 15 cm and 5 cm in length and ideally less than 5 cm in length and has a diameter of between 2 cm and 10 cm.

The alarm housing is fitted into the door and locked in place, for example by a catch release ring or similar lock member with a suitable threaded portion and anti tamper fittings.

Control of the alarm is advantageously provided by an electronic micro controller or microprocessor and integrated circuitry. A battery or cell is typically of the dry cell type although other cells, such as Nickel-Cadmium, may be used. The means to detect a hazard and means to indicate that a hazard has been detected, and the micro controller (or microprocessor) are ideally configured to provide a low battery warning, which may be for example, a flashing light emitting diode (LED) arranged to flash a different colour from the one usually shown in an active or hazard mode.

The drive means for the alarm indicator includes: a spring loaded mechanism, for a mechanical type indicator, a buzzer or other high pitched audible alarm; a flashing light of one or more colours or a radio frequency (RF) transmitter, such as a Bluetooth type device or a High Performance Local Area Network (HIPERLAN) radio system.

According to a further aspect of the present invention there is provided an alarm system including: a plurality of alarms having means to detect a hazard and means to indicate that a hazard has been detected, the means to detect a hazard is located so that it is presented to an inner surface of a door and the means to indicate that a hazard has been detected is located on an outer surface of a door; and means for communicating from each alarm to a remote station.

Preferred embodiments of the alarm, and an example of an associated alarm system, will now be described by way of example only and with reference to the Figures in which:

### BRIEF DESCRIPTION OF THE FIGURES

FIG. 1 shows a part sectional view of an alarm housing;

FIGS. 2a and 2b show plan views of two corridors door with the alarm fitted to each door in the corridor;

FIG. 3 shows a functional block diagram of the main components of the alarm;

FIG. 4 shows a radio frequency system, incorporating four alarms;

FIG. 5 is an alternative embodiment to that shown in FIG. 1;

FIG. 6a shows a plan view of an alternative embodiment of the alarm comprising a housing for a hazard indicator and a housing for a battery and for electronic control devices;

FIG. 6b shows an exploded view of the alarm in FIG. 6a;

FIG. 7a is a sectional view through a door in which the alarm is housed; and

FIG. 7b is a diagrammatical view showing how components of the alarm are assembled in the door.

### DETAILED DESCRIPTION OF PREFERRED EMBODIMENTS OF THE INVENTION

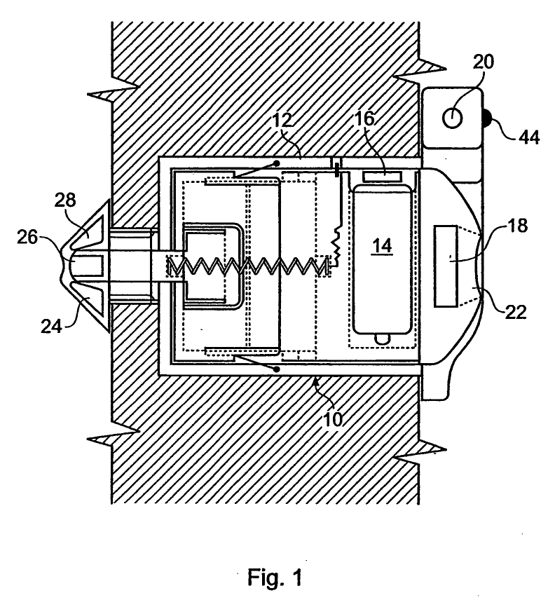

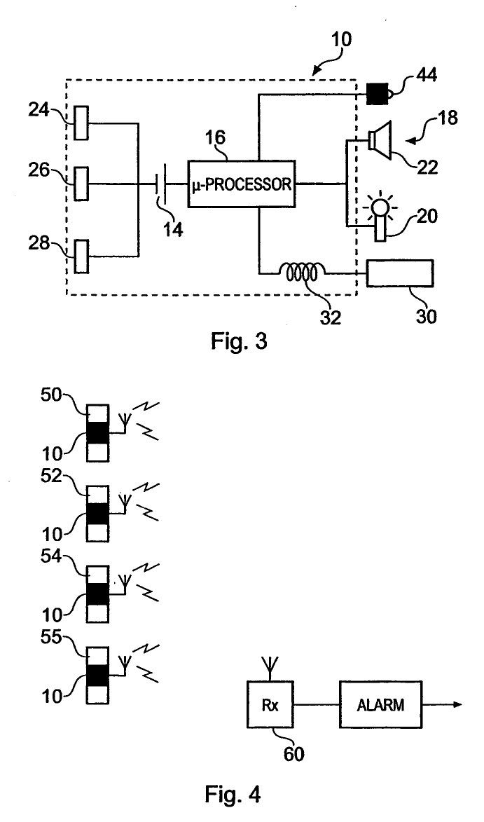

Referring to the Figures, and particularly FIGS. 1 and 3, there is shown an alarm 10 comprising a housing 12 formed from a strong resilient material such as mild steel, aluminum or a thermally resistant synthetic plastics material.

Supported within the housing 12 there is a battery 14 that is connected to a controller 16 and an alarm 18. In this case the alarm 18 comprises a flashing light source 20 and an audible alarm or bleeper 22. Sensors 24, 26 and 28 are connected in parallel to controller. Sensor 24 detects heat, sensor 26 detects smoke and sensor 28 detects flames.

It will be appreciated that alternative sensors may be used in dependence upon the location of the alarms and type of building where they are to be used. For example in an environment in which there is nuclear or radioactive material present, for example in a nuclear reprocessing plant, a radioactive detector, such as Geiger counter or ionisation tube may be used as one of the sensor(s).

A low-level battery indicator 42 is provided. The low-level battery indicator may be connected to a remote monitor or it may simply trigger a local alarm such as a flashing LED 44. LED's may be red or green.

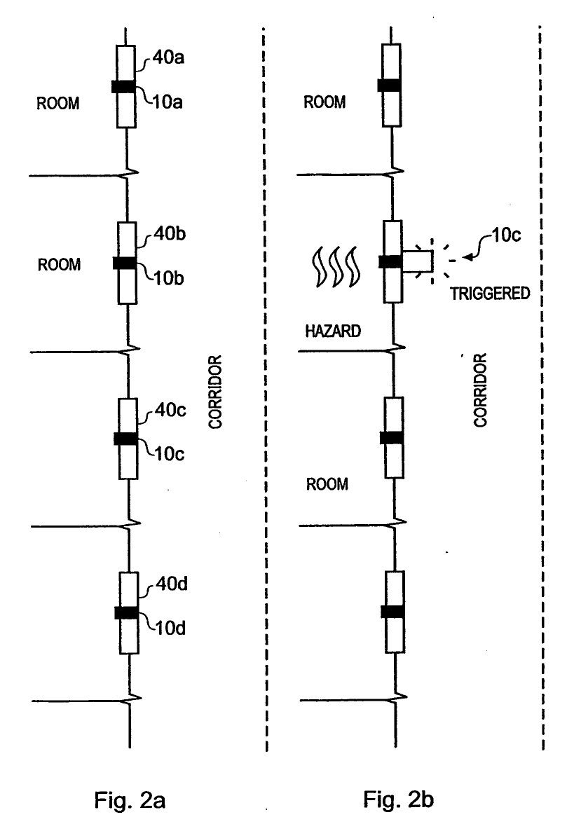

Referring to FIGS. 2a and 2b, in addition to the sensors described, there is also a passive visual indicating alarm or indicator 30 which is held in place by a trigger 32. When trigger 32 is activated under control of microprocessor 16, indicator 30 is released and a plunger type assembly is ejected beyond the surface of the door 40 so as to protrude therefrom. The surface of the passive visual indicator may be painted with a luminous or fluorescent paint or other bright colour so as to be readily recognised and seen from a distance or through smoke.

Upon detection of a substance within the room or office, sensors 24, 26 and 28 sense the hazard and send signals to controller 16. Controller 16 compares the signals with a datum or other stored values and determines whether a limit has been exceeded. If this limit is exceeded then the controller determines that a hazard is detected and sends an enable signal to the or each alarm. The alarm enable signal triggers the, or each, alarm(s). In this case trigger 32 is disengaged and spring-loaded visual indicator 30 protrudes beyond the door.

Some rotational movements may be required in order to set or depress the or each sleeve as the sleeve may have a catch mechanism adapted to engage with internally disposed raised portions, fingers or grooves (not shown) within the sensor housing. This catch mechanism may be machined or precision moulded. Around the plunger there may be one or sprung rings, similar to compression rings about a piston, each performing separate and shared tasks. Much of the anti-tampering features rely upon an unauthorised user being unable to rotate the plunger necessary for disarming.

FIG. 2a shows four alarms 10 in a non-activated state fitted in doors 40. FIG. 2b shows one alarm 10c when detecting the presence of a hazard in a room. Alarm 10c is activated and passive indicator 30 protrudes beyond the door 40c so that the room experiencing the hazard may be located quickly from the corridor. The warning device may be mechanically sprung, gas spring, operated by way of an electro magnet configured to always fail safe or any other suitable displacement device.

FIG. 4 shows diagrammatically a plurality of alarm fitted within separate doors 50, 52, 54, 56, for example of a large office or hotel. Alarms are in radio frequency communication with a remote receiver 60 which may be configured to send one or more alarm signals directly to a remote police or fire station (not shown) in the event of a hazard being detected and an alarm being triggered.

In the embodiment in which a mechanical indicator is displaced outwards from the body of the alarm housing to a position where it may be viewed, for example in a corridor it is understood that presence of the visual indicator is sufficient to show, for example to a fireman searching a building, the location of the hazard.

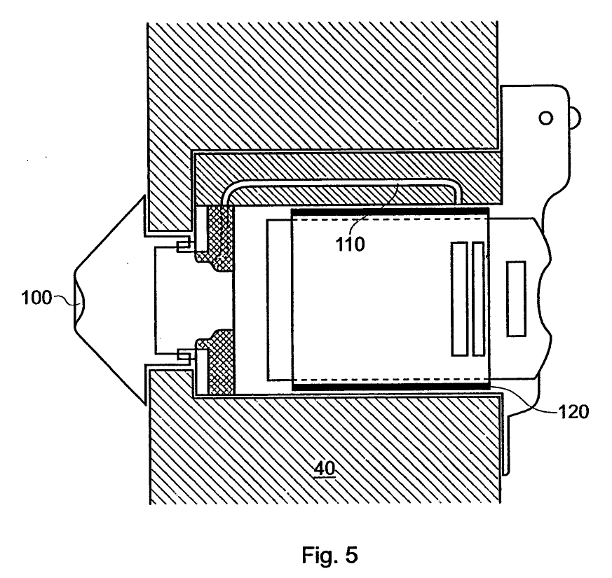

FIG. 5 shows diagrammatically an alternative embodiment of the alarm having a socket 100 for receiving sensor impulses, a conduit 110 through which a substance to be sensed can flow and an additional brightly coloured sleeve 120, for example illustrating a different hazard or status of the alarm. Alternatively there may be two sleeves—one nested inside the other—each sleeve having separate drive means adapted to displace the relevant sleeve in dependence upon the particular hazard that is sensed. In this sense one sleeve may be red—indicating a fire hazard; the other sleeve may be yellow—indicating the presence of smoke other noxious vapours.

In a yet further embodiment a separate member, arranged as a sleeve around the first or main member. The second member is ideally coloured differently from the first member and is adapted to displace when a second hazard is detected. As the second member is effectively a sleeve around the first member, both ideally have different handed threads arranged on their inner surfaces so that a motor may urge one hazard indicator by driving clockwise and the other hazard indicator by driving counter clockwise.

Each of the aforementioned embodiments of the alarm is ideally quickly and easily modified to detect alternative specific hazards (in addition to warning of fire), such as gas or chemical contaminants. Where the threat of risk differs periodically, an interchangeable sensor section is provided. The sensor section may include various purpose made sensors and/or other components. All sensor sections are provided with a standard plug arrangement (not shown) for fitting into a suitable socket 100 in the alarm housing. Therefore electrical connection to any sensor section, from the main body, is readily achieved. Such changes in application are readily achieved by removing an entire sensor section and replacing it with another sensor section adapted to detect a different hazard, substance or contaminant.

To illustrate to the user that a hazard, other than fire/smoke is present, such as a chemical contaminant, an additional brightly coloured sleeve surrounding the plunger is included. Typically a hazard, such as fire/smoke is indicated by a red coloured plunger, whereas a chemical contaminant is indicated by a yellow sleeve surrounding the red plunger. This additional or secondary sleeve is adapted to be triggered or released independently by its respective sensor and urged from the plunger by a resiliently deformable means, such as a helical spring. The advantage of this is that it indicates to a user (fireman) that alternative action may need to be taken.

Another embodiment of the alarm includes a photo luminescent or chemi luminescent material. Photo luminescent or chemi luminescent materials combine with chemicals in order to produce light. These chemicals are ideally housed in containers which when ruptured enable the chemicals to mix and initiate the chemical reaction. An advantage of these types of reactions is that they require no external energy supply and are therefore self-energising a container has been ruptured.

The outer facing of the hazard warning alert can exhibit an information plaque or display corresponding with the colour of the sleeve or cover and a sensor adapted to detect a contaminant is ideally calibrated to detect in the this instance.

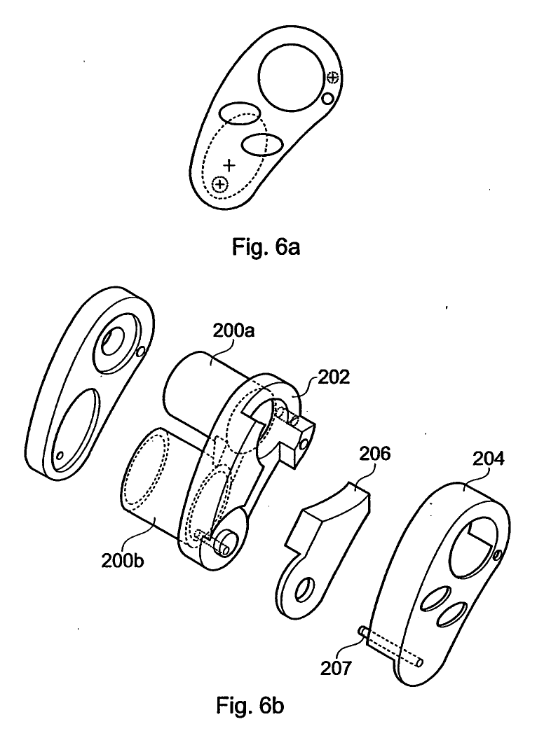

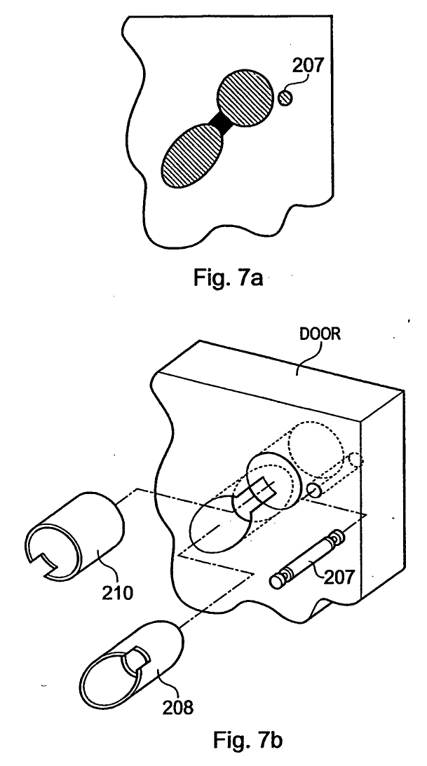

FIGS. 6 and 7 show overall views of a further embodiment of the invention, in which separate chambers 200a and 200b are shown. In this embodiment there is a separate plunger housing 200a and a separate housing for sensing and control electronic components. A chassis 202 acts as a cover and engages with a faceplate 204. A cell or battery 206 is sandwiched between the chassis and baseplate in a manner so as to prevent tampering. A guidepost or steady post 207 assists with the assembly of the alarm. Heat resistant sleeves 208 and 210 contain components or devices (not shown) in a hermetically sealed environment so as to reduce the risk of heat/water damage.

The invention has been described by way of exemplary examples only and it would be appreciated that variation may be made to those examples without departing from the scope of the invention. For example a rapid tester may be included. This may be able to be performed locally or centrally via a remote control desk. Also the alarm may be configured to be able to communicate with local hand held monitors/communication devices, of the type that may be carried by fire inspector or safety personnel.

1. An alarm is adapted to be retrofitted into a door, the alarm having:
a displaceable member, which projects beyond the plane of the door so as to indicate to an observer that there is a hazard in the room, which is sealed by the door.

2. An alarm, comprising:
means to detect a hazard and means to indicate that a hazard has been detected, the alarm being housed in a housing, said housing is adapted to be fitted within a door,
whereby in use the means to detect a hazard is located at a first surface of the door and the means to indicate that a hazard has been detected is located at the second surface of the door,
characterised in that the means to indicate that a hazard has been detected is adapted to displace beyond the housing and protrude beyond the surface of the door.

3. An alarm according to claim 1, wherein the means to indicate that a hazard has been detected includes:
a member which is displaced beyond the surface of the door where it is visible.

4. An alarm according to claim 1, wherein:
the means to indicate that a hazard is present is a spring-loaded mechanical device adapted to be displaced upon detection of the hazard.

5. An alarm according to claim 1, wherein:
the means to indicate that a hazard is present is a member that is displaced by a drive means.

6. An alarm according to claim 5, wherein:
the drive means includes a motor and a gear mechanism.

7. An alarm according to claim 4, wherein:
a sleeve surrounds the member;
the gear mechanism is adapted to displace either the member or the sleeve in dependence upon a control signal and at least two sensors being in communication with a control signal generator,
whereby a different sleeve is displaced in dependence upon the hazard detected.

8. An alarm according to claim 7, wherein:
the sleeve and the member are coloured different from one another, thereby permitting warning of different hazards to be indicated.

9. An alarm according to claim 1, wherein the means to detect a hazard comprises:
one or more sensors that are in communication with a room or space, which is sealed in normal use by the door.

10. An alarm according to claim 1, further comprising:
a passage or channel that provides a pathway for the hazard to the sensor.

11. An alarm according to claim 1, wherein:
the alarm housing is dimensioned and arranged to receive one or more controllers, an energy supply and a drive means for the alarm.

12. An alarm according to claim 1, wherein the alarm includes
a visual and/or audible signal in order to indicate the presence of a hazard.

13. An alarm according to claim 1, wherein:
the alarm is housed within a housing, such as right circular cylinder.

14. An alarm according to claim 1, wherein:
the housing has an anti tamper device to prevent unauthorized opening or removal.

15. An alarm according to claim 1, wherein:
the housing is hermetically sealed.

16. An alarm according to claim 1, wherein:
the alarm has a low battery warning device.

17. An alarm according to claim 1, wherein the alarm includes one or more sensors for sensing hazards from the group comprising:
smoke, heat, flames, gas, noxious substances, biological material, hazardous chemicals and radioactive materials.

18. An alarm according to claim 17, wherein:
the sensors are interchangeable sensors.

19. An alarm according to claim 17, wherein:
the, or each, sensors is/are arranged to display information corresponding to a hazard or contaminant that is detected.

20. An alarm according to claim 2, wherein:
the spring-loaded device can be reset only when batteries or cells are correctly positioned.

21. An alarm according to claim 1, wherein:
the alarm has an audible device adapted to emit an audible alarm and/or a radio frequency (RF) transmitter arranged to transmit an RF signal.

22. An alarm according to claim 1, wherein:
an affirmation device is adapted to confirm whether a hazard is present.

23. An alarm according to claim 1, wherein:
the alarm is adapted for use in ships or submarines and includes an intumescing material.

24. An alarm according to claim 1, wherein:
the alarm is between 15 cm and 5 cm in length and ideally less than 5 cm in length and has a diameter of between 2 cm and 10 cm.

25. An alarm system including a plurality of alarms according to claim 1, further comprising:
means for communicating to a remote station.

26. An alarm system according to claim 25, further comprising:
means for communicating to a fire station by way of an automatic communication link.

27. (canceled)

28. (canceled)
